(19) United States
(12) Patent Application Publication
(10) Pub. No.: US 2016/0292806 A1
(43) Pub. Date: Oct. 6, 2016

(54) SYSTEM FOR RECEIVING STUDENT FEEDBACK

(71) Applicant: George Hiroshi CHURCHWELL, Herndon, VA (US)

(72) Inventor: George Hiroshi CHURCHWELL, Herndon, VA (US)

(21) Appl. No.: 15/087,107

(22) Filed: Mar. 31, 2016

Related U.S. Application Data
(60) Provisional application No. 62/140,720, filed on Mar. 31, 2015.

(51) Int. Cl. G06Q 50/20; G06Q 10/10

(52) U.S. Cl. CPC G06Q 50/205; G06Q 10/10

(57) ABSTRACT

A system for receiving student feedback is provided. The system includes loading a student application for at least one student and a teacher application for a teacher; submitting a class roster, content information, and exhibits from the teacher to a teacher administrative interface; a server receiving the class roster, content information and exhibits from the teacher administrative interface; the at least one student following the inputs on the application; the at least one student submitting feedback to the application as to the understanding of a session; the teacher adjusting the session based on the feedback received; and the teacher controlling the distribution of quizzes, exhibits and assessments.

### CROSS-REFERENCE TO RELATED APPLICATION

This application claims the benefit of priority of U.S. provisional application No. 62/140,720, filed 31 Mar. 2015, the contents of which are herein incorporated by reference.

### BACKGROUND OF THE INVENTION

The present invention relates to training students and, more particularly, to a system for instantaneous student feedback.

Instructor led training does not provide learning analytic content information to assess student performance. This is due to the absence of sensors to identify the student's engagement. Students are unable to provide live classroom feedback in real-time. Instructors do not have an empirical method to engage students in real-time with remediation or to perform assessments. Management is unable to identify the performance of an instructor led class in real-time. Currently, devices are either physical and require special tools or do not incorporate certain features.

As can be seen, there is a need for a system for receiving student feedback approximately instantaneously.

### SUMMARY OF THE INVENTION

In one aspect of the present invention, a computer-implemented system for receiving student feedback includes loading a student application for at least one student and a teacher application for a teacher; submitting a class roster and an associated session from the teacher to a teacher administrative interface; a server receiving the class roster and the associated session from the teacher administrative interface; the at least one student following a plurality of inputs of the session on the student application; the at least one student submitting feedback to the student application as to an understanding of the session; and the teacher adjusting the session based on the feedback received.

In another aspect of the present invention, the system may include a plurality of inputs of the session includes at least one quiz, at least one exhibit and a feedback slider associated with each exhibit, wherein the feedback slider is provided on the student application for each student to submit feedback, wherein the teacher controls the plurality of input on the student application, wherein the feedback slider is configured to age, encouraging each student to contemporaneously submit feedback as to the understanding of the session, wherein the feedback received is a weighted average of the at least one student, representing a combined understanding of the class roster, wherein the teacher application provides the understanding for each student and the combined understanding of the class roster, both as a function of time, wherein the teacher application provides a stepper function for moving among the plurality of inputs on the student application, wherein the teacher application provides an exhibit function for selecting a predetermined exhibit of the at least one exhibit on the student application, wherein the teacher application provides a feedback function for representing the feedback slider on the student application, wherein the teacher application provides a quiz function for representing a predetermined quiz of the at least one quiz on the student application, wherein the teacher adjusting the session further comprises selectively engaging at least one of the stepper function, the exhibit function, the feedback function or the quiz function based on the feedback received, and wherein the feedback received further comprises at least one of the understanding for each student or the combined understanding of the class roster. These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention;

FIG. 2 is a flow chart of an exemplary embodiment of a screen flow of the present invention; and

FIG. 3 is a continuation of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for receiving student feedback comprising: loading a student application for at least one student and a teacher application for a teacher; submitting a class roster, content information, and exhibits from the teacher to a teacher administrative interface; a server receiving the class roster, content information and exhibits from the teacher administrative interface; the at least one student following the inputs on the application; the at least one student submitting feedback to the application as to the understanding of a session; the teacher adjusting the session based on the feedback received; and the teacher controlling the distribution of quizzes, exhibits and assessments.

The present invention may provide students with a self-contained learning environment that may allow the student to receive content information on their mobile device, synchronized with a teacher's presentation. The environment may also include a self-scoring quiz that may include remediation and review.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

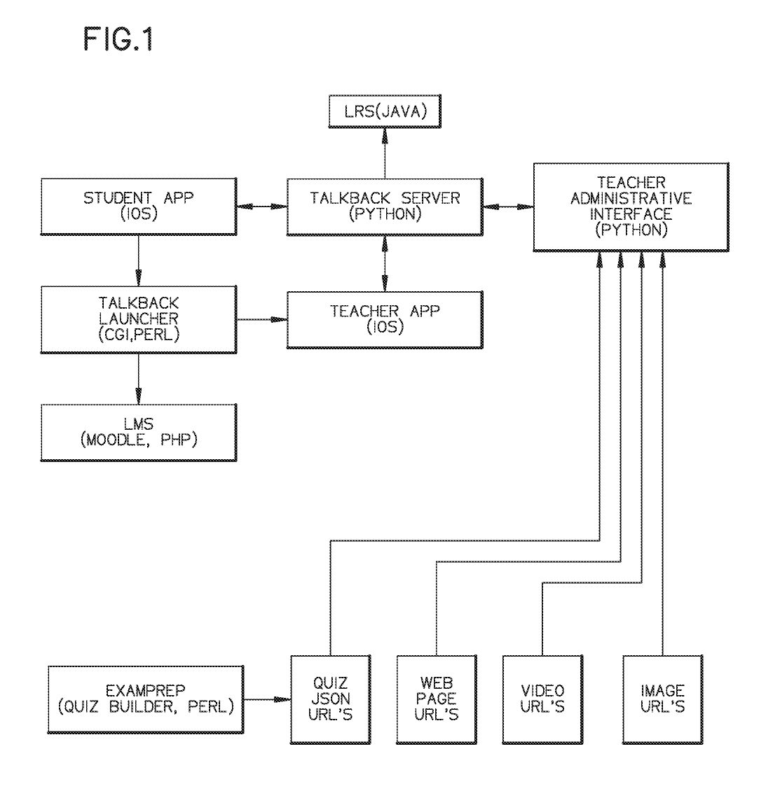

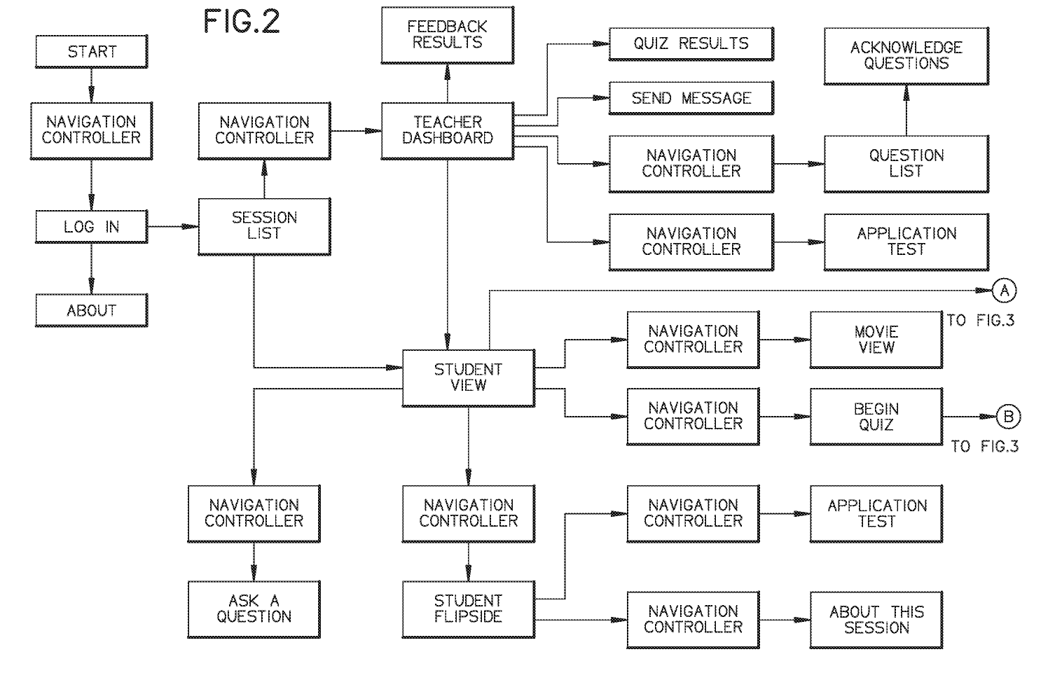

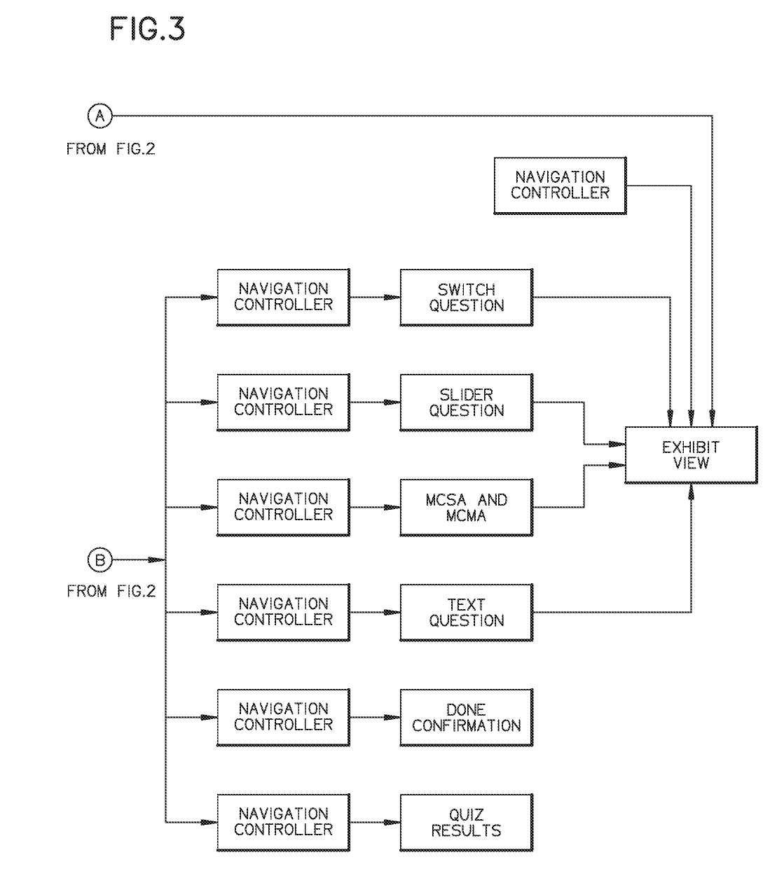

As is illustrated in FIGS. 1 through 3, a student application and a teacher application may talk with each other via a server. A teacher administrative interface may provide content information to the server. Teachers may create a classroom (e.g., class roster including a plurality of students) and at least one associated session and place them in the teacher administrative interface. Each session may include at least one quiz, a home-screen and a plurality of cards, wherein each card has a respective card name and card number. Each card may include at least one exhibit and a feedback screen associated with each card number and name, wherein exhibits include subject matter and/or content information related to the associated session. The content information affiliated the classroom and sessions may be loaded via URLs. Content information may be used to create quizzes and exhibits, wherein exhibits may be images, videos, web pages and the like may be uploaded via separate URLs. Quiz data may be exported from ExamPrep or the like. The server may automatically record events to a Learning Record Store (LRS). A learning management system (LMS) may be integrated so that it may be possible to launch sessions that are associated with LMS activities reliably and easily. A launcher and CGI, along with QR codes or the like, may allow the application user to jump directly to a session. The system may include an indicator, such as a feedback slider that may allow students to indicate their understanding of the material being discussed at that time. The feedback slider may be included in the feedback screen of each card of each session. The feedback slider may change color (or “age”), an adaption to encourage students to revise their position to reflect their changing understanding of the subject matter. The indicator values for all students may be combined into one weighted average to reflect the whole class's combined degree of understanding. This weighted average may allow the teacher to spend more time on certain topics that are less understood, and less time on topics that are well understood. The indicator may be updated throughout the session in order to obtain the most recent status of understanding for the students.

The system may allow the student to connect to a session and the teacher to connect to the same session. The teacher may control what appears on the student's screens. The teacher may navigate from topic to topic, wherein topics may be groupings of related cards, exhibits or quizzes, or the like. Each topic may include at least one exhibit and the teacher may remotely control the student's applications to view the exhibit or the feedback slider, go to the next or previous topic, or the like. The teacher may also trigger the student application to view the session home page or begin a quiz. The applications may send all learning analytics gathered to the LRS. The teacher application may have a dashboard screen. A navigation strip may allow the teacher to select a session, access views that a student may see, or the like. The teacher application may allow the teacher to remotely control what the student may view through their own application. The controls may include: a stepper for moving forward or backward through cards, a button to navigate to the exhibit for the current card, a button to navigate to the feedback screen for the current card, a button to navigate to the home screen for the session, a button to navigate to the quiz for the session and the like. A cloud server may provide communication so students may be remote. The teacher application may show the weighted average of the feedback slider for the class. A graph may be shown to demonstrate questions that may have been missed or answered correctly by a student during a quiz.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented system for receiving student feedback comprising:
loading a student application for at least one student and a teacher application for a teacher;
submitting a class roster and an associated session from the teacher to a teacher administrative interface;
a server receiving the class roster and the associated session from the teacher administrative interface;
the at least one student following a plurality of inputs of the session on the student application;
the at least one student submitting feedback to the student application as to an understanding of the session; and
the teacher adjusting the session based on the feedback received.

2. The system of claim 1, wherein the plurality of inputs of the session includes at least one quiz, at least one exhibit and a feedback slider associated with each exhibit, wherein the feedback slider is provided on the student application for each student to submit feedback.

3. The system of claim 2, wherein the teacher controls the plurality of input on the student application.

4. The system of claim 3, wherein the feedback slider is configured to age, encouraging each student to contemporaneously submit feedback as to the understanding of the session.

5. The system of claim 4, wherein the feedback received is a weighted average of the at least one student, representing a combined understanding of the class roster.

6. The system of claim 5, wherein the teacher application provides the understanding for each student and the combined understanding of the class roster, both as a function of time.

7. The system of claim 6, wherein the teacher application provides a stepper function for moving among the plurality of inputs on the student application.

8. The system of claim 7, wherein the teacher application provides an exhibit function for selecting a predetermined exhibit of the at least one exhibit on the student application.

9. The system of claim 8, wherein the teacher application provides a feedback function for representing the feedback slider on the student application.

10. The system of claim 9, wherein the teacher application provides a quiz function for representing a predetermined quiz of the at least one quiz on the student application.

11. The system of claim 10, wherein the teacher adjusting the session further comprises selectively engaging at least one of the stepper function, the exhibit function, the feedback function or the quiz function based on the feedback received.

12. The system of claim 11, wherein the feedback received further comprises at least one of the understanding for each student or the combined understanding of the class roster.
